(19) United States
(12) Patent Application Publication
(10) Pub. No.: US 2010/0144478 A1
(43) Pub. Date: Jun. 10, 2010

(54) DIFFERENTIAL LOCK STRUCTURE

(76) Inventor: Shao-Chin FAN, Taoyuan Hsien (TW)

Correspondence Address: Muncy, Geissler, Olds & Lowe, PLLC, 4000 Legato Road, Suite 310, FAIRFAX, VA, 22033, US

(21) Appl. No.: 12/328,590

(22) Filed: Dec. 4, 2008

(51) Int. Cl. F16H 48/30

(52) U.S. Cl. 475/150; 475/231

(57) ABSTRACT

A differential lock structure includes a differential and a lock ring, wherein the case of the differential has at least one locking through hole, and an output gear inside the differential having a recess, and the lock ring has a locking through bolt for passing through the locking through hole in the recess, and has a lock device for forcing the lock ring to stay close to the differential, characterized in that: the lock device includes an arbor which circumferentially has a worm gear and the other end has a spline gear, and a fork has a worm gear hole matching to the worm gear at one end and the other end clamps the lock ring, and a motor gear has a spline gear hole matching to the spline gear; when the motor gear rotates, the arbor is rotated, and the fork presses the lock ring close to the differential.

### FIELD OF THE INVENTION

The present invention is related to a differential lock structure, and more particularly to a differential structure which utilizes the motor gear to lock the differential.

### BACKGROUND OF THE INVENTION

For wheeled vehicles, when turning corners, if paired driving wheels, which are mounted on a common axle, rotate at the same speed, the turning radiuses of the inner and outer wheels must be different, so that it is easy for the vehicle to turn over. Therefore, for letting the inner and outer wheels to rotate at different speeds so as to solve the problem, the differential is formed.

The differential makes the inner and outer wheels to rotate at different speeds. Although the differential can provide greater steering control as turning corners, if the vehicle passes the pits on the road or spins, the transmission power from engine might be concentrated on only one wheel, so as to cause the vehicle stop or out of control. For solving this problem, a limit slip differential (LSD) is developed for limiting the ratio of the rotational speed differences of paired wheels and the characteristic thereof, so as to avoid that only one wheel with less friction gets full power provided by the engine and causes idle running, and oppositely, the other wheel gets no power. In normal condition, the functions provided by LSD can conform to most demands, but for vehicles used for special road surfaces, such as, all terrain vehicle (ATV) which is dedicated to very bad road conditions, e.g., rough, mud or desert, since the frictions and resistances born by paired wheels must be always in an unbalanced condition, a lock design should be added into the differential, so that paired wheels can obtain the same power output, thereby conforming to the special demand.

One of the conventional differential lock devices is disclosed in U.S. Pat. No. 6,935,982, entitled “Differential Gear”. In this patent, the differential gear mainly utilizes a lever to rotate a shaft, and, through a cam groove which is integrated with the shaft and has a displacement difference, further rotate a fork mounted in one end of the cam groove, so that an annual member linked to the other end of the fork moves to pass through the case of the differential gear and embed in an output-side cam inside the differential gear, thereby achieving the purpose of differential lock. However, the components and structure thereof are complicated, and it needs to cooperate by a guide pin, so that no matter in manufacturing or maintaining, the cost is quite high. Besides, the method of utilizing the lever to control the locking is inconvenient.

### SUMMARY OF THE INVENTION

The object of the present invention is to provide a differential whose locking is controlled by an external circuit, so that the linking structure thereof can be simplified.

For achieving the object described above, the present invention includes a differential and a lock ring, wherein the case of the differential has at least one locking through hole mounted thereon, and the differential has, located therein, an output gear having a recess corresponding to the locking through hole, and the lock ring has a locking through bolt for passing through the locking through hole and inserting into the recess, and has a lock device for forcing the lock ring to stay close to the differential, characterized in that: the lock device includes a motor gear, an arbor and a fork, wherein the arbor circumferentially has a worm gear at one end and the other end has a spline gear, the fork has a worm gear hole matching to the worm gear at one end and the other end clamps the lock ring, and the motor gear has a spline gear hole matching to the spline gear, so that when the motor gear rotates, the arbor is rotated thereby, and the fork therefore is moved to press the lock ring close to the differential. Besides, a sensor and a position-sensing circuit located on the motor gear are further included for sensing the rotation position of the motor gear.

The above description, as compared with the prior art, is advantageous that:

1. The present invention utilizes the motor gear to drive the arbor, in which the worm gear drives the fork to press the lock ring close to the differential, so that the components and the volume of the differential can be significantly reduced.

2. The simplified structure of the present invention is contributive to manufacturing cost reduction, convenient maintaining and more direct locking strength.

3. The present invention further utilizes the sensor and the position-sensing circuit to confirm the action of the lock device and the external circuit to control the rotation of the motor gear, so as to decide the locking of the differential, thereby the operation of the lock device becomes more convenient which facilitates the reduction of operational error.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the appearance of the present invention;

FIG. 2 to FIG. 3 are decomposition drawings of the present invention;

FIG. 4 is a sectional view of the present invention; and

FIG. 5-1 to FIG. 5-2 show the connection relationships of the sensor and the position-sensing circuit.

### DESCRIPTION OF THE PREFERRED EMBODIMENT

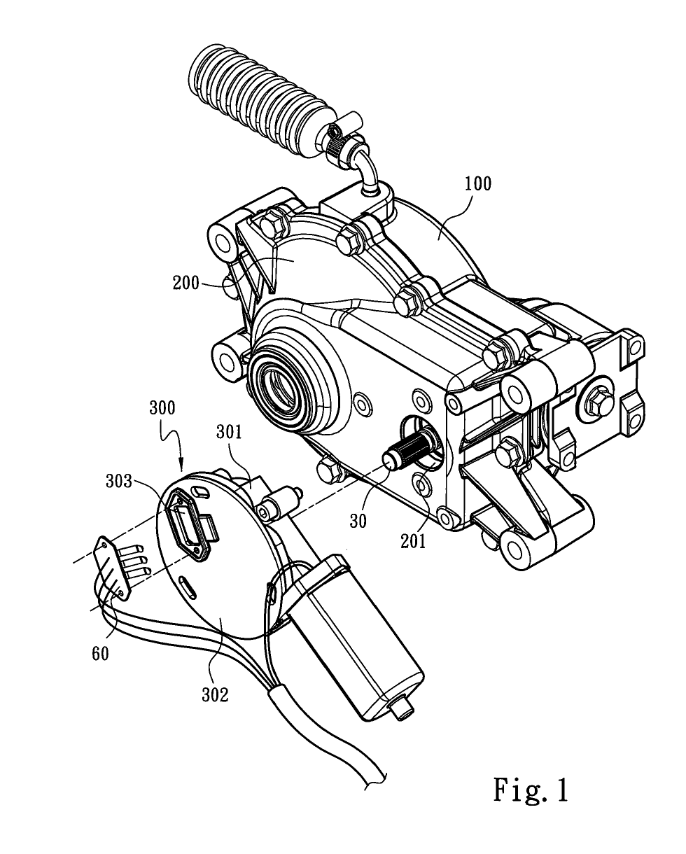

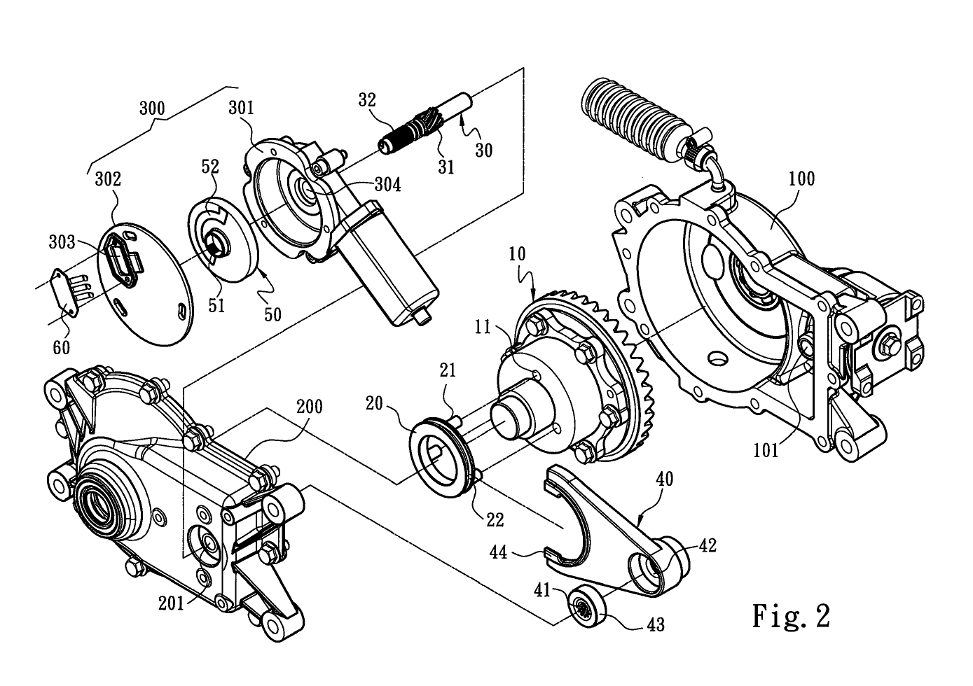

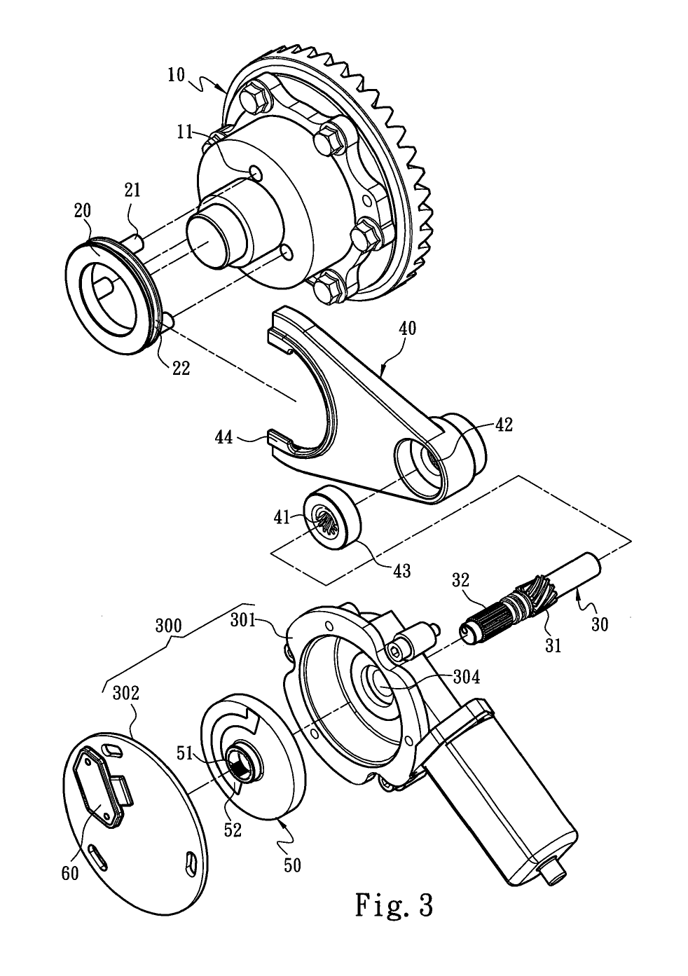

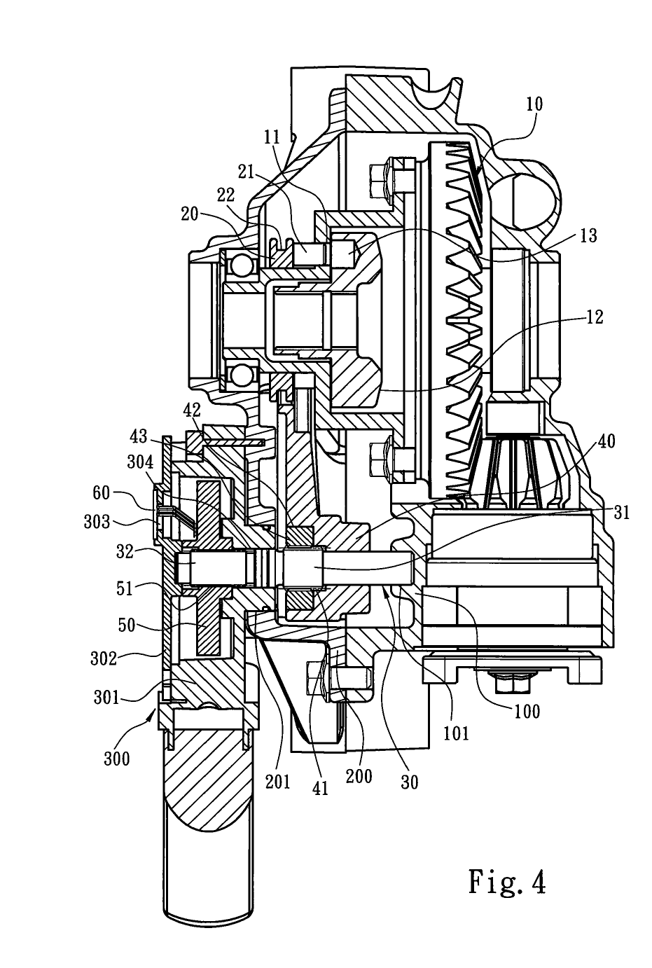

Please refer to FIG. 1 to FIG. 4. The present invention includes a differential 10 and a lock ring 20. The case of the differential 10 has at least one locking through hole 11 mounted thereon, and a recess 13 corresponding to the locking through hole 11 is mounted on an output gear 12, which is located in the differential 10. The lock ring 20 has a locking through bolt 21 for passing through the locking through hole 11 and inserting into the recess 13, and has a lock device for forcing the lock ring 20 to stay close to the differential 10. The present invention is characterized in that the lock device includes a motor gear 50, an arbor 30 and a fork 40, wherein the arbor 30 circumferentially has a worm gear 31, and the other end has a spline gear 32, the fork 40 has a worm gear hole 41 matching to the worm gear 31 at one end, and the other end clamps the lock ring 20, and the motor gear 50 has a spline gear hole 51 matching to the spline gear 32, so that when the motor gear 50 rotates, the arbor 30 is rotated thereby, and the fork 40 therefore is moved to press the lock ring 20 close to the differential 10, and thus, the locking through bolt 21 passes through the locking through hole 11 and inserts into the recess 13, thereby achieving the purpose of locking the differential 10, and directly outputting the power to the inner and outer wheels.

Moreover, the differential 10, the lock ring 20, the arbor 30 and the fork 40 are all accommodated in a space formed by a first housing 100 and a second housing 200. The first housing 100 has a positioning seat 101 therein, and the second housing 200 has a positioning hole 201 mounted thereon, so that the arbor 30 can pass through the positioning hole 201 and the worm gear hole 41 and then reject in the positioning seat 101 so as to stably locate in the first and the second housings 100, 200. Furthermore, a sub-housing 300 is connected to the second housing 200 for accommodating the motor gear 50, and the sub-housing 300 includes a sub-housing seat 301 and a sub-housing cover 302. The sub-housing seat 301 has a through hole 304 mounted thereon, so that the spline gear 32, which is protruded out of the second housing 200, can pass through the through hole 304 and the spline gear hole 51 for connecting with the motor gear 50. Moreover, a position-sensing hole 303 is mounted on the sub-housing cover 302 for mounting a sensor 60, and a plane of the motor gear 50 facing the sub-housing cover 302 is used to locate a position-sensing circuit 52, so that the position-sensing circuit 52 can drive the sensor 60 to produce different electric signals as the motor gear 50 rotates to different positions. Besides, the fork 40 has a through hole 42 mounted thereon, and a worm gear ring 43 with the worm gear hole 41 therein is located in the through hole 42. And, the outer circumferential surface of the lock ring 20 has a groove 22 mounted thereon, for receiving two clamping pieces 44, which are located on two terminals of the fork 40. Therefore, without influencing the rotation of the differential 10, through the rotation of the motor gear 50, the fork 40 can be moved to press the lock ring 20 close to the differential 10, so as to force the locking through bolt 21 to pass through the locking through hole 11 and insert into the recess 13, thereby achieving the function of locking the differential 10. It should be noticed that the present invention is not limited by the described embodiment above, and the only purpose is to provide the arbor 30 a stable positioning. Here, the motor gear 50 also can have the sensor 60, and the fork 40 and the worm gear hole 41 can be formed as two components or as an integration. Therefore, without influencing the rotation of the differential 10, the fork 40 can be moved to press the lock ring 20 close to the differential 10.

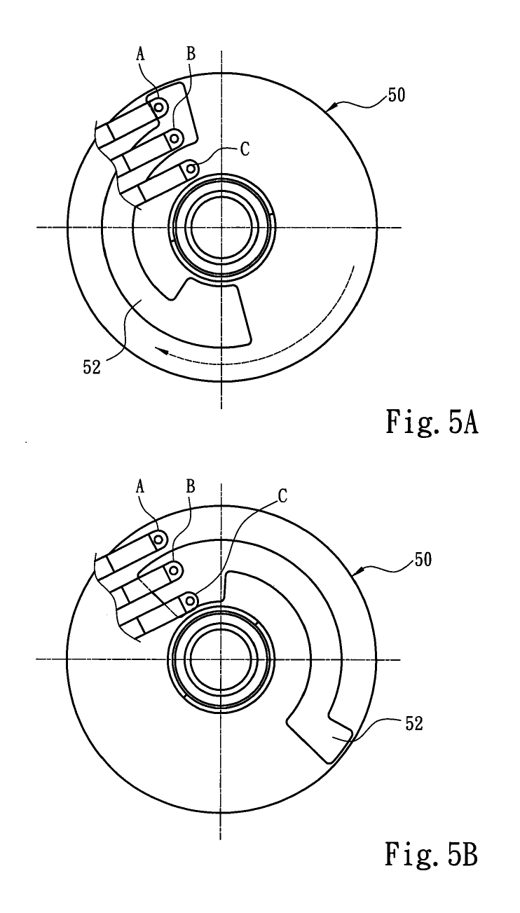

Please refer to FIG. 5-1 and 5-2 for explaining the relationship between the sensor 60 and the position-sensing circuit 52. The position-sensing circuit 52 is bare copper conductor on a printed circuit board, and the sensor 60 is implemented to be plural conductive pins, which tightly contact with the position-sensing circuit 52. In this preferred embodiment, plural conductive pins include sensing pins A, B and C. FIG. 5-1 shows the motor gear 50 is in the non-rotating state, and at this time, the sensing pins A, B are formed short circuit via the position-sensing circuit 52. Then, while the motor gear 50 rotates the arbor 30 in a clockwise direction and the fork 40 is moved to press the lock ring 20 close to the differential 10, so as to lock the differential 10, the position-sensing circuit 52 causes the sensing pins B, C to become short circuit at the same time. Therefore, the sensor 60 can simply recognize the non-rotation of the motor gear 50 and the unlock of the differential 10 through the short circuit of the sensing pins A, B, and the rotation and positioning of the motor gear 50 and the locking of the differential 10 through the short circuit of the sensing pins B, C, thereby the sensor 60 can output electric signals in accordance therewith. Further, through cooperating with a control circuit, the lock of the differential 10 can be accurately controlled according to the rotation situation of the motor gear 50. It should be noticed that the above described embodiment is only for illustration and not for limitation. Here, the quantity of the sensing pins can be increased for cooperating with the shape variation of the position-sensing circuit 52.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A differential lock structure, comprising a differential and a lock ring, wherein the case of the differential has at least one locking through hole mounted thereon, and the differential has, located therein, an output gear having a recess corresponding to the locking through hole, and the lock ring has a locking through bolt for passing through the locking through hole and inserting into the recess, and has a lock device for forcing the lock ring to stay close to the differential, characterized in that:
the lock device includes a motor gear, an arbor and a fork, wherein the arbor circumferentially has a worm gear and the other end has a spline gear, the fork has a worm gear hole matching to the worm gear at one end and the other end clamps the lock ring, and the motor gear has a spline gear hole matching to the spline gear, so that when the motor gear rotates, the arbor is rotated thereby, and the fork therefore is moved to press the lock ring close to the differential.

2. The differential lock structure as claimed in claim 1, further including a sensor and a position-sensing circuit located on the motor gear, wherein the position-sensing circuit drives the sensor to produce different electric signals when the motor gear rotates to different positions.

3. The differential lock structure as claimed in claim 2, wherein the position-sensing circuit is bare copper conductor on a printed circuit board, and the sensor is implemented to be plural conductive pins, which tightly contact with the position-sensing circuit.

4. The differential lock structure as claimed in claim 1, wherein the outer circumferential surface of the lock ring has a groove mounted thereon, for receiving two clamping pieces located on two terminals of the fork.
